(19) United States
(12) Patent Application Publication
(10) Pub. No.: US 2026/0057083 A1
(43) Pub. Date: Feb. 26, 2026

(54) BROWSER-BASED PROTECTION OF DATA FILES

(71) Applicant: ISLAND TECHNOLOGY INC., DALLAS, TX (US)

(72) Inventors: DAN AMIGA, RAMAT HASHARON (IL); IDO ORAN, TEL AVIV (IL); MATAN OPPENHEIM, TEL AVIV (IL)

(21) Appl. No.: 19/304,624

(22) Filed: Aug. 20, 2025

Related U.S. Application Data
(60) Provisional application No. 63/684,908, filed on Aug. 20, 2024.

(51) Int. Cl. G06F 21/60; G06F 21/31; G06F 21/62

(52) U.S. Cl. CPC G06F 21/602; G06F 21/31; G06F 21/6254

(57) ABSTRACT

A computer network security method including configuring a web browser to receive a data file via a computer network, determine in accordance with any predefined policy that the data file is subject to predefined data restriction, and provide the data file to a file protection service together with identification of the predefined data restriction, where the file protection service is configured to modify the data file to include the identification of the predefined data restriction, encrypt the data file, and provide the encrypted data file to the web browser, and configuring the web browser to provide the encrypted data file for access by a computer-hosted application that is configured to access a decryption key that is configured to decrypt the data file, decrypt the data file using the decryption key, and enforce the predefined data restriction identified in the data file.

### FIELD

The invention relates generally to computer security.

### BACKGROUND

Computer users often use web browsers to download data files that are then accessed by other “desktop” applications on the user's computer. A significant challenge faced by organizations is managing desktop applications to prevent data exfiltration, such as by copying, printing, screen capturing, and sending data files to unauthorized parties. While web applications often adhere to standard protocols, desktop applications tend to be more proprietary, complicating oversight and control.

### SUMMARY

In one aspect of the invention a method is provided for computer network security, the method including configuring a web browser to receive a data file via a computer network, determine in accordance with any predefined policy that the data file is subject to predefined data restriction, and provide the data file to a file protection service together with identification of the predefined data restriction, where the file protection service is configured to modify the data file to include the identification of the predefined data restriction, encrypt the data file, and provide the encrypted data file to the web browser and configuring the web browser to provide the encrypted data file for access by a computer-hosted application that is configured to access a decryption key that is configured to decrypt the data file, decrypt the data file using the decryption key, and enforce the predefined data restriction identified in the data file.

In another aspect of the invention the predefined policy is associated with an authenticated user of the web browser.

In another aspect of the invention the file protection service is configured to encrypt the data file where the encryption key is uniquely associated with the data file.

In another aspect of the invention the method further includes configuring the web browser to provide the data file to the file protection service with identification associated with an authenticated user of the web browser, where the file protection service is configured to encrypt the data file where the encryption key is uniquely associated with both the identification associated with the authenticated user of the web browser and the data file.

In another aspect of the invention the web browser and the computer-hosted application are hosted by the same computer, and where the computer-hosted application is configured to intercept any operation by any process executed by the computer that relates to enforcing the predefined data restriction indicated by the data file.

In another aspect of the invention the method further includes configuring the web browser to determine in accordance with any predefined policy that the data file may be sent via the computer network after decryption and removal of the identification of the predefined data restriction from the data file, and provide the data file to the file protection service together with identification associated with the user of the web browser and a request to remove the identification of the predefined data restriction from the data file, where the file protection service is further configured to access the decryption key that is configured to decrypt the data file, decrypt the data file using the decryption key, remove the identification of the predefined data restriction from the data file, and provide the decrypted data file to the web browser and configuring the web browser to send the decrypted data file via the computer network.

In another aspect of the invention a computer network security method is provided including configuring a web browser to determine in accordance with any predefined policy that a data file may be sent via a computer network after decryption and removal of identification of a predefined data restriction from the data file, and provide the data file to a file protection service together with identification associated with a user of the web browser and a request to remove the identification of the predefined data restriction from the data file, where the file protection service is configured to access a decryption key that is configured to decrypt the data file, decrypt the data file using the decryption key, remove the identification of the predefined data restriction from the data file, and provide the decrypted data file to the web browser and configuring the web browser to send the decrypted data file via the computer network.

In another aspect of the invention a computer network security system is provided including a web browser configured to receive a data file via a computer network, determine in accordance with any predefined policy that the data file is subject to a predefined data restriction and a file protection service configured to receive, from the web browser, identification of the predefined data restriction, modify the data file to include the identification of the predefined data restriction, encrypt the data file, and provide the encrypted data file to the web browser, where the web browser is further configured to provide the encrypted data file for access by a computer-hosted application that is configured to access a decryption key that is configured to decrypt the data file, decrypt the data file using the decryption key, and enforce the predefined data restriction identified in the data file.

In another aspect of the invention the web browser is further configured to provide the data file to the file protection service with identification associated with an authenticated user of the web browser, and the file protection service is further configured to encrypt the data file where the encryption key is uniquely associated with both the identification associated with the authenticated user of the web browser and the data file.

In another aspect of the invention the web browser is further configured to determine in accordance with any predefined policy that the data file may be sent via the computer network after decryption and removal of the identification of the predefined data restriction from the data file, where the web browser is further configured to provide the data file to the file protection service together with identification associated with the user of the web browser and a request to remove the identification of the predefined data restriction from the data file, where the file protection service is further configured to access the decryption key that is configured to decrypt the data file, decrypt the data file using the decryption key, remove the identification of the predefined data restriction from the data file, and provide the decrypted data file to the web browser, and where the web browser is further configured to send the decrypted data file via the computer network.

In another aspect of the invention a computer network security system is provided including a web browser configured to determine in accordance with any predefined policy that a data file may be sent via a computer network after decryption and removal of identification of a predefined data restriction from the data file and a file protection service configured to receive, from the web browser, identification associated with a user of the web browser and a request to remove the identification of the predefined data restriction from the data file, access a decryption key that is configured to decrypt the data file, decrypt the data file using the decryption key, remove the identification of the predefined data restriction from the data file, and provide the decrypted data file to the web browser, and where the web browser is further configured to send the decrypted data file via the computer network.

### BRIEF DESCRIPTION OF THE DRAWINGS

Aspects of the invention will be understood and appreciated more fully from the following detailed description taken in conjunction with the appended drawings in which:

FIGS. 1A and 1B, taken together, is a simplified conceptual illustration of a computer security system, constructed and operative in accordance with an embodiment of the invention;

FIG. 2 is a simplified action diagram of an exemplary method of operation of the system of FIG. 1A, operative in accordance with an embodiment of the invention;

FIG. 3 is a simplified action diagram of an exemplary method of operation of the system of FIG. 1B, operative in accordance with an embodiment of the invention;

FIG. 4 is a simplified conceptual illustration of a computer security system, constructed and operative in accordance with an embodiment of the invention; and

FIG. 5 is a simplified action diagram of an exemplary method of operation of the system of FIG. 4, operative in accordance with an embodiment of the invention.

### DETAILED DESCRIPTION

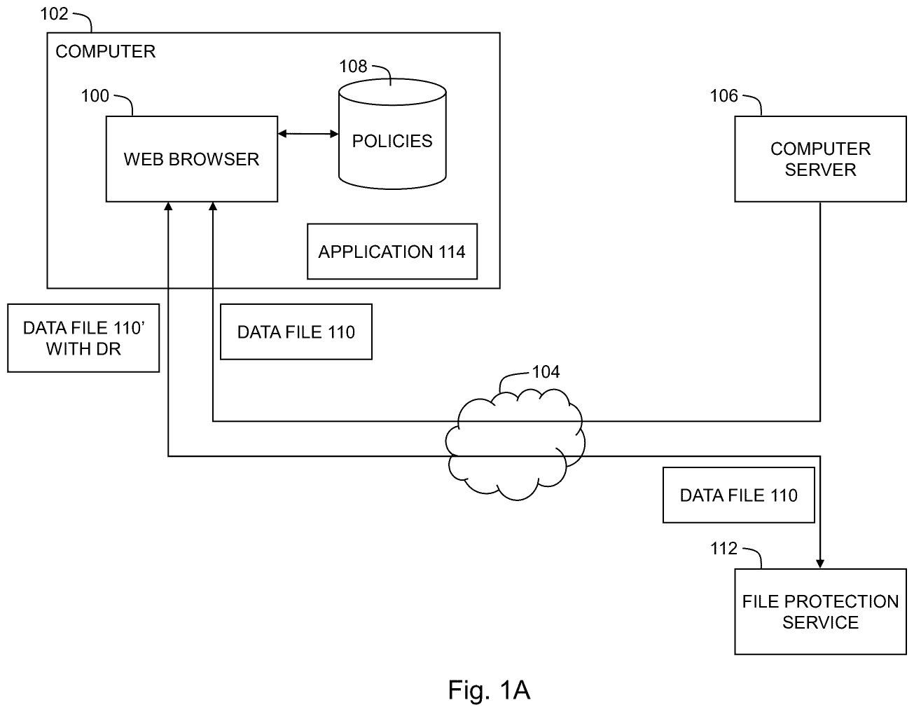

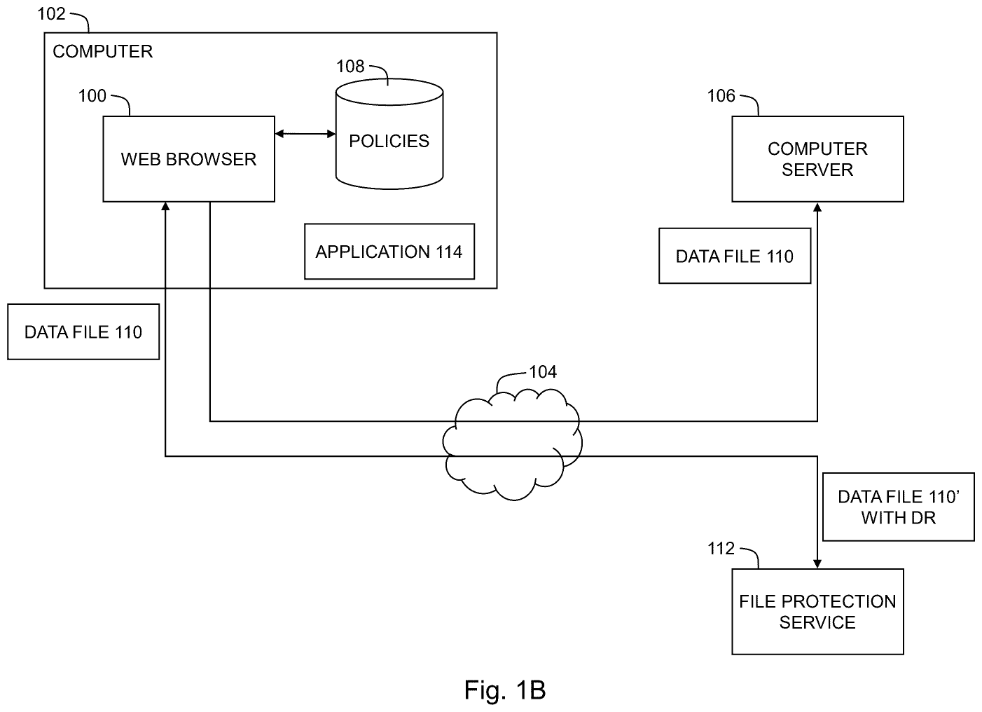

Reference is now made to FIGS. 1A and 1B, which, taken together, is a simplified conceptual illustration of a computer security system, constructed and operative in accordance with an embodiment of the invention. In the system of FIGS. 1A and 1B, a web browser 100 is configured to incorporate the functionality of conventional web browsers, such as those based on the Google™ Chromium™ architecture, and is additionally configured to operate as is described hereinbelow.

Web browser 100 may be hosted by any computing device, such as by a computer 102 that is connected to a computer network 104, which may, for example, be the Internet or a corporate intranet that provides access to one or more other networks, such as the Internet. Copies of web browser 100 may, for example, be installed on multiple computing devices for use by individuals associated with an organization, such as by employees or contractors of a company, on company-owned computing devices or on non-company-owned computing devices. Web browser 100 may be configured to operate, as described herein, by system administrators and/or other parties authorized by the organization, such as in accordance with methods described in U.S. patent application Ser. Nos. 17/740,457 and 17/993,919.

Web browser 100 is preferably configured to require that each user of web browser 100 be authenticated, such as in accordance with methods described in U.S. patent application Ser. Nos. 17/740,457 and 17/993,919, before web browser 100 is allowed to perform one or more predefined operations, such as each time web browser 100 is executed and/or periodically thereafter, such as at predefined time intervals and/or before web browser 100 performs one or more operations predefined as requiring user reauthentication.

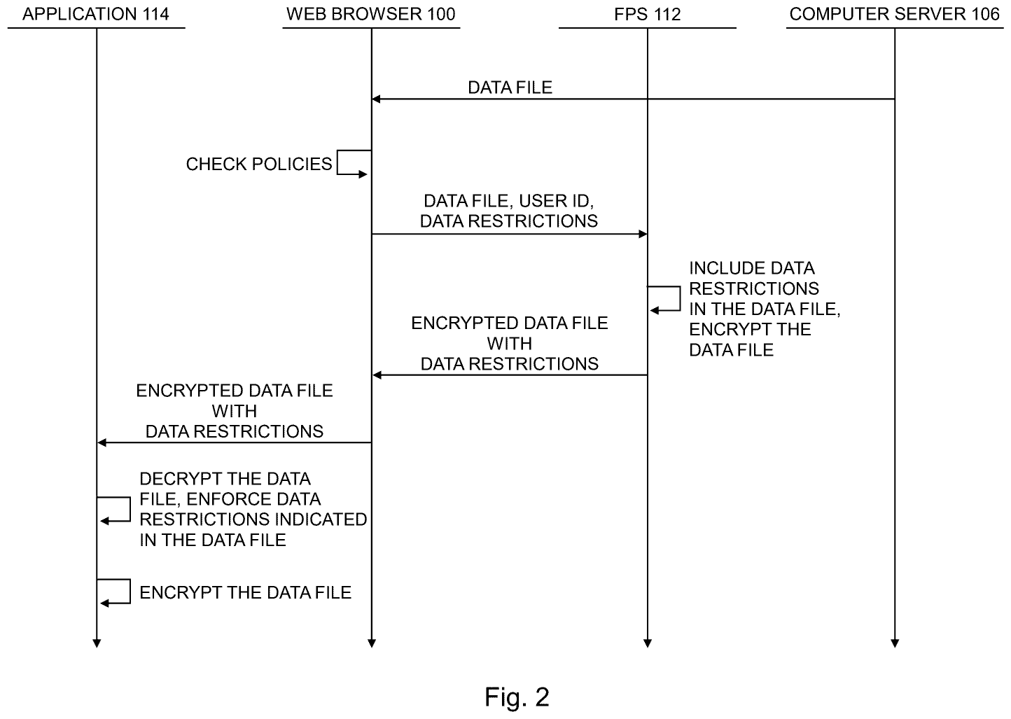

As is shown more particularly in FIG. 1A, web browser 100 is preferably configured to receive data files, such as from a computer server 106 via computer network 104, and in accordance with one or more predefined policies 108, provide any such data file 110 to a File Protection Service (FPS) 112 for processing, where FPS 112 is hosted by computer 102 or is hosted elsewhere and is accessible via computer network 104. As is described in greater detail hereinbelow with reference to FIG. 2, FPS 112 adds identification of one or more types of predefined data restrictions (DR) to data file 110, such as to a metadata portion of data file 110, and encrypts data file 110, whereupon FPS 112 sends the encrypted data file, now referred to as data file 110′, to web browser 100. Web browser 100 then makes encrypted data file 110′ accessible to one or more computer software or hardware applications, such as to an application 114 that is hosted by computer 102, where application 114 is configured to access a decryption key that is configured to decrypt data file 110′, decrypt data file 110′ using the decryption key, and allow data file 110′ to be read and/or modified while enforcing the predefined data restrictions indicated by data file 110′. Application 114 is also configured to access an encryption key that is configured to encrypt data file 110′, and encrypt data file 110′ using the encryption key, such as anytime that application 114 saves data file 110′ to a data storage device.

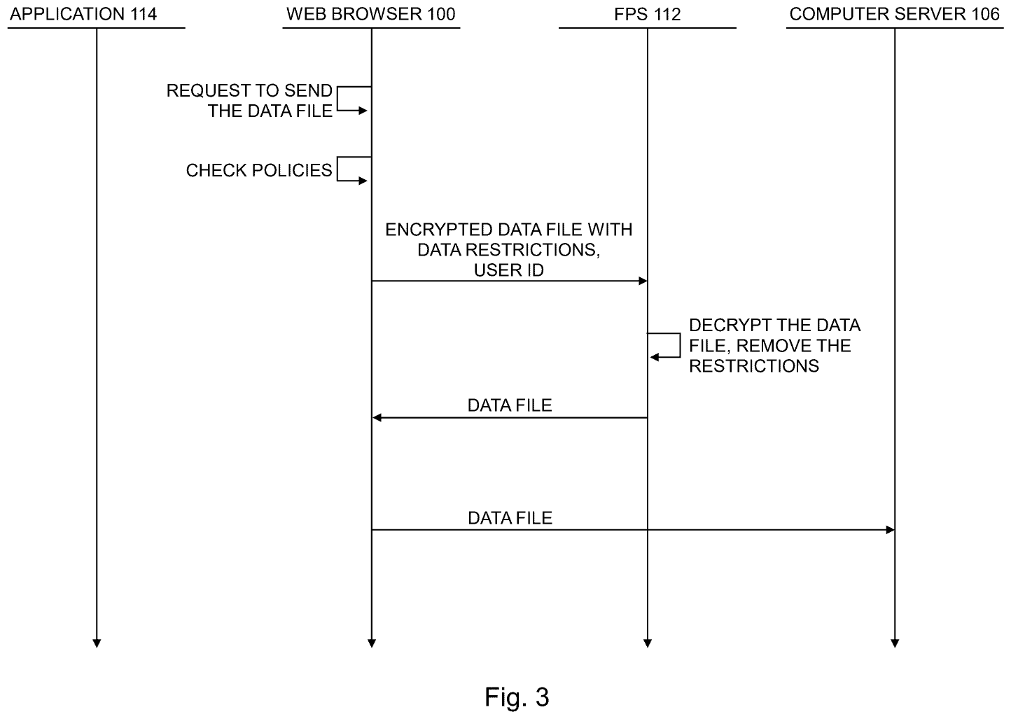

As is shown more particularly in FIG. 1B, web browser 100 is also preferably configured to send to a recipient, such as to computer server 106 via computer network 104, any data file processed as described above where, in accordance with one or more predefined policies 108, web browser 100 first sends encrypted data file 110′ to FPS 112 for processing as described in greater detail hereinbelow with reference to FIG. 3, where FPS 112 decrypts data file 110′ and removes the identification of the predefined data restrictions from data file 110′, whereupon FPS 112 sends the decrypted data file, now referred to again as data file 110, to web browser 100 which then sends data file 110 to the recipient.

Additional reference is now made to FIG. 2, which is a simplified action diagram of an exemplary method of operation of the system of FIG. 1A, operative in accordance with an embodiment of the invention. In FIG. 2, web browser 100 is configured to receive a data file, such as where an authenticated user of web browser 100 provides a Uniform Resource Locator (URL) to web browser 100 indicating a computer network location from which to request the data file, such as from computer server 106. Web browser 100 is also configured to determine in accordance with one or more predefined policies 108, such as where policies 108 were previously provided to web browser 100 as described in U.S. patent application Ser. No. 17/740,457, that the data file requires one or more types of predefined data restrictions. For example, web browser 100 may be configured with a policy that requires all Microsoft Word™ files that are downloaded by web browser 100 to be protected in accordance with one or more specific types of predefined data restrictions that are provided by the Azure Information Protection™ (AIP) and Azure Rights Management Services™ (Azure RMS), commercially available from Microsoft Corporation of Redmond, Washington, USA. After receiving the data file, and preferably before storing the data file on a data storage device or otherwise making the data file available to other computer software or hardware applications or devices, web browser 100 provides the data file to FPS 112, which may be hosted by computer 102 or another computer, or which may be assembled with web browser 100, such as in the form of a browser extension. Web browser 100 provides the data file to FPS 112 with an identification of the types of predefined data restrictions that are to be enforced when the data file is accessed, and preferably also with an identification associated with the authenticated user of web browser 100.

FPS 112 is preferably configured to modify the data file to include the identification of the predefined data restrictions as well as encrypt the data file using an encryption key, such as where the encryption key is uniquely associated with the identification associated with the authenticated user of web browser 100 and/or with the data file itself, such as in accordance with known AIP/Azure RMS techniques. FPS 112 then provides the encrypted data file to web browser 100 which then makes the encrypted data file available to other computer software or hardware applications or devices, such as to application 114 that is configured to access a decryption key to decrypt the data file and enforce the predefined data restrictions identified in the data file, such as in accordance with AIP/Azure RMS techniques, where application 114 is also preferably configured to access the encryption key that was previously used by FPS 112 to encrypt the data file and then encrypt the data file using the encryption key, such as anytime that application 114 saves the data file to a data storage device.

Additional reference is now made to FIG. 3, which is a simplified action diagram of an exemplary method of operation of the system of FIG. 1B, operative in accordance with an embodiment of the invention. In FIG. 3, web browser 100 is configured to receive a request to send to a recipient, such as computer server 106, a data file that is processed as described above, where the data file is encrypted and includes identification of predefined data restrictions. For example, an authenticated user of web browser 100 may attempt to upload the data file to a Google Docs™ folder. Web browser 100 is configured to determine in accordance with one or more predefined policies 108 whether and how the data file may be sent to the recipient. For example, if web browser 100 determines that policies 108 allow the authenticated user of web browser 100 to upload Microsoft Word™ files to a Google Docs™ folder after the data file is decrypted and after identification of predefined data restrictions is removed from the data file, web browser 100 then provides the data file to FPS 112 with a request to remove the identification of the predefined data restrictions from the data file, and preferably also provides the identification associated with the authenticated user of web browser 100. FPS 112 is preferably configured to access a decryption key that is configured to decrypt the data file, such as in accordance with known AIP/Azure RMS techniques, decrypt the data file using the decryption key, remove the identification of the predefined data restrictions from the data file, and provide the decrypted data file to web browser 100 which then sends the decrypted data file to the recipient.

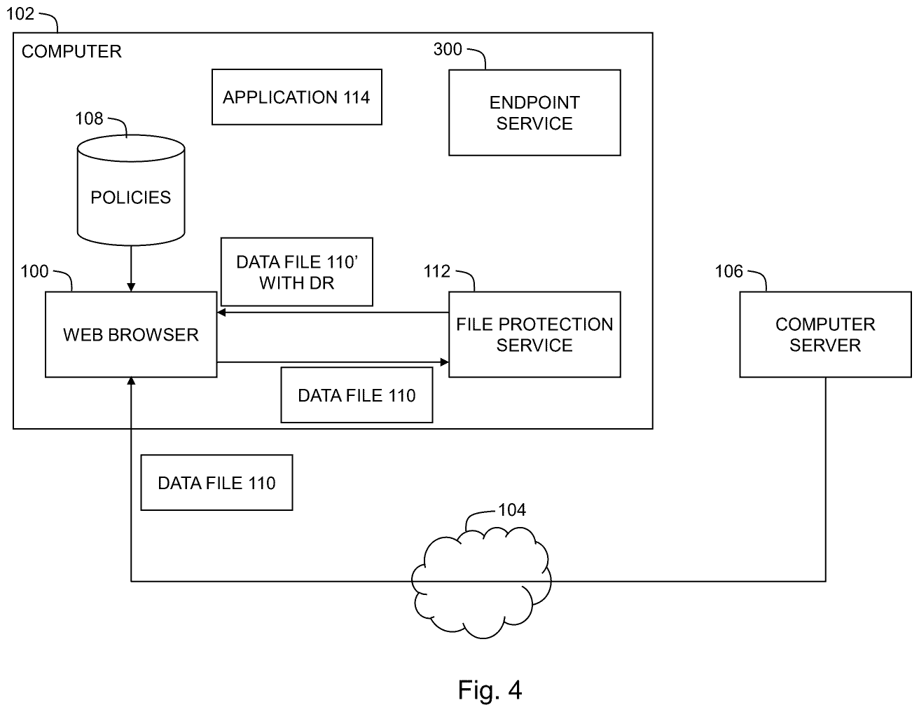

Reference is now made to FIG. 4, which is a simplified conceptual illustration of a computer security system, constructed and operative in accordance with an additional embodiment of the invention. The system of FIG. 4 is substantially similar to the system of FIG. 1A except as is noted below, and with the notable exception that an Endpoint Service (ES) 300 is hosted by computer 102 and is configured using any known technique, such as using kernel-process and user-process hooking, to intercept one or more predefined operations by any process executed by computer 102, such as requests to open files, read files, and write to files, as well as when application 114 attempts to perform copy, paste, and print operations. In one embodiment ES 300 is implemented as a kernel driver in accordance with conventional techniques.

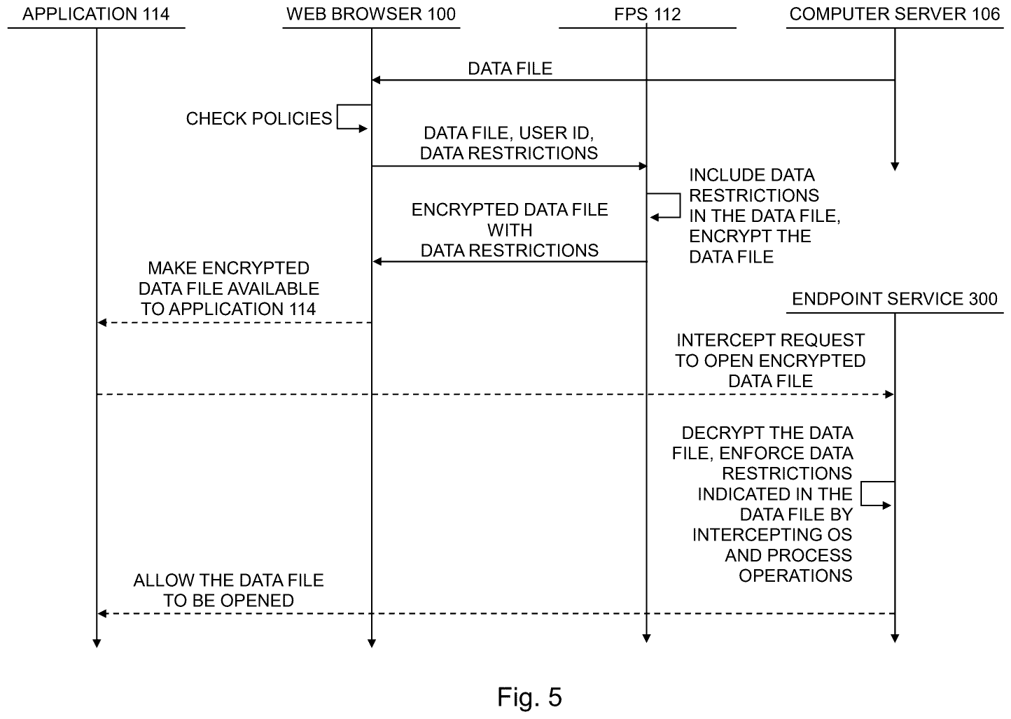

Web browser 100 is preferably configured to receive data files, such as from computer server 106 via computer network 104, and in accordance with one or more predefined policies 108, provide any such data file 110 to FPS 112 for processing. As is described in greater detail hereinbelow with reference to FIG. 5, FPS 112 adds identification of one or more types of predefined data restrictions (DR) to data file 110, such as to a metadata portion of data file 110, and encrypts data file 110, such as where the encryption key is uniquely associated with the identification associated with the authenticated user of web browser 100 and/or with the data file itself, whereupon FPS 112 sends the encrypted data file 110′ to web browser 100. Web browser 100 then makes encrypted data file 110′ accessible to one or more computer software or hardware applications, such as to application 114 that is hosted by computer 102. FPS 112 may be hosted by computer 102 or hosted elsewhere and accessible via computer network 104. Where FPS 112 is hosted by computer 102, the operation of FPS 112 and ES 300 may be performed by a single computer process, such as where FPS 112 and ES 300 are implemented as a single kernel driver.

Additional reference is now made to FIG. 5, which is a simplified action diagram of an exemplary method of operation of the system of FIG. 4, operative in accordance with an embodiment of the invention. In FIG. 5, web browser 100 is configured to receive a data file, such as from computer server 106. Web browser 100 is also configured to determine in accordance with one or more predefined policies 108 that the data file requires one or more types of predefined data restrictions, such as those that are provided by the Azure Information Protection™ (AIP) and Azure Rights Management Services™ (Azure RMS) as described hereinabove. After receiving the data file, and preferably before storing the data file on a data storage device or otherwise making the data file available to other computer software or hardware applications or devices, web browser 100 provides the data file to FPS 112, which may be hosted by computer 102 or by another computer, or which may be assembled with web browser 100, such as in the form of a browser extension. Web browser 100 provides the data file to FPS 112 with an identification of the types of predefined data restrictions that are to be enforced when the data file is accessed, and preferably also with an identification associated with the authenticated user of web browser 100.

FPS 112 is preferably configured to modify the data file to include the identification of the predefined data restrictions as well as encrypt the data file using an encryption key in accordance with any known techniques, and preferably where the encryption key is uniquely associated with the identification of the authenticated user of web browser 100 and/or with the data file itself. FPS 112 then provides the encrypted data file to web browser 100 which then makes the encrypted data file available to other computer software or hardware applications or devices, such as to application 114.

When application 114 requests to open the data file, ES 300 intercepts the request, accesses a decryption key that is configured to decrypt the data file, decrypts the data file using the decryption key in accordance with any known techniques, and allows the data file to be read and/or modified by application 114 while enforcing the predefined data restrictions indicated by the data file by intercepting any operation performed by any process executed by computer 102 that relates to enforcing the predefined data restrictions indicated by the data file. When application 114 requests to save the data file, such as to a data storage device, ES 300 intercepts the request, accesses an encryption key that is configured to encrypt the data file, and encrypts the data file using the encryption key, before allowing application 114 to the save data file.

Any aspect of the invention described herein may be implemented in computer hardware and/or computer software embodied in a non-transitory, computer-readable medium in accordance with conventional techniques, the computer hardware including one or more computer processors, computer memories, I/O devices, and network interfaces that interoperate in accordance with conventional techniques.

It is to be appreciated that the term “processor” or “device” as used herein is intended to include any processing device, such as, for example, one that includes a CPU (central processing unit) and/or other processing circuitry. It is also to be understood that the term “processor” or “device” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart illustrations and block diagrams in the drawing figures illustrate the architecture, functionality, and operation of possible implementations of systems, methods, and computer program products according to various embodiments of the invention. In this regard, each block in the flowchart illustrations or block diagrams may represent a module, segment, or portion of computer instructions, which comprises one or more executable computer instructions for implementing the specified logical function(s). In some alternative implementations, the functions noted in a block may occur out of the order noted in the drawing figures. For example, two blocks shown in succession may, in fact, be executed substantially concurrently, or the blocks may sometimes be executed in the reverse order, depending upon the functionality involved. It will also be noted that each block of the flowchart illustrations and block diagrams, and combinations of such blocks, can be implemented by special-purpose hardware-based and/or software-based systems that perform the specified functions or acts.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A computer network security method, the method comprising:
configuring a web browser to
receive a data file via a computer network,
determine in accordance with any predefined policy that the data file is subject to predefined data restriction, and
provide the data file to a file protection service together with identification of the predefined data restriction, wherein the file protection service is configured to
modify the data file to include the identification of the predefined data restriction,
encrypt the data file, and
provide the encrypted data file to the web browser; and
configuring the web browser to provide the encrypted data file for access by a computer-hosted application that is configured to
access a decryption key that is configured to decrypt the data file,
decrypt the data file using the decryption key, and
enforce the predefined data restriction identified in the data file.

2. The computer network security method according to claim 1, wherein the predefined policy is associated with an authenticated user of the web browser.

3. The computer network security method according to claim 1, wherein the file protection service is configured to encrypt the data file wherein the encryption key is uniquely associated with the data file.

4. The computer network security method according to claim 1, further comprising configuring the web browser to provide the data file to the file protection service with identification associated with an authenticated user of the web browser, wherein the file protection service is configured to encrypt the data file wherein the encryption key is uniquely associated with both the identification associated with the authenticated user of the web browser and the data file.

5. The computer network security method according to claim 1, wherein the web browser and the computer-hosted application are hosted by the same computer, and wherein the computer-hosted application is configured to intercept any operation by any process executed by the computer that relates to enforcing the predefined data restriction indicated by the data file.

6. The computer network security method according to claim 1, further comprising configuring the web browser to
determine in accordance with any predefined policy that the data file may be sent via the computer network after decryption and removal of the identification of the predefined data restriction from the data file, and
provide the data file to the file protection service together with identification associated with the user of the web browser and a request to remove the identification of the predefined data restriction from the data file, wherein the file protection service is further configured to
access the decryption key that is configured to decrypt the data file,
decrypt the data file using the decryption key,
remove the identification of the predefined data restriction from the data file, and
provide the decrypted data file to the web browser; and
configuring the web browser to send the decrypted data file via the computer network.

7. A computer network security method, the method comprising:
configuring a web browser to
determine in accordance with any predefined policy that a data file may be sent via a computer network after decryption and removal of identification of a predefined data restriction from the data file, and
provide the data file to a file protection service together with identification associated with a user of the web browser and a request to remove the identification of the predefined data restriction from the data file, wherein the file protection service is configured to
access a decryption key that is configured to decrypt the data file,
decrypt the data file using the decryption key,
remove the identification of the predefined data restriction from the data file, and
provide the decrypted data file to the web browser; and
configuring the web browser to send the decrypted data file via the computer network.

8. A computer network security system comprising:
a web browser configured to
receive a data file via a computer network,
determine in accordance with any predefined policy that the data file is subject to a predefined data restriction; and
a file protection service configured to
receive, from the web browser, identification of the predefined data restriction,
modify the data file to include the identification of the predefined data restriction,
encrypt the data file, and
provide the encrypted data file to the web browser,
wherein the web browser is further configured to provide the encrypted data file for access by a computer-hosted application that is configured to
access a decryption key that is configured to decrypt the data file,
decrypt the data file using the decryption key, and
enforce the predefined data restriction identified in the data file.

9. The computer network security system according to claim 8, wherein the predefined policy is associated with an authenticated user of the web browser.

10. The computer network security system according to claim 8, wherein the file protection service is further configured to encrypt the data file wherein the encryption key is uniquely associated with the data file.

11. The computer network security system according to claim 8, wherein the web browser is further configured to provide the data file to the file protection service with identification associated with an authenticated user of the web browser, and wherein the file protection service is further configured to encrypt the data file wherein the encryption key is uniquely associated with both the identification associated with the authenticated user of the web browser and the data file.

12. The computer network security system according to claim 8, wherein the web browser and the computer-hosted application are hosted by the same computer, and wherein the computer-hosted application is further configured to intercept any operation by any process executed by the computer that relates to enforcing the predefined data restriction indicated by the data file.

13. The computer network security system according to claim 8,
wherein the web browser is further configured to determine in accordance with any predefined policy that the data file may be sent via the computer network after decryption and removal of the identification of the predefined data restriction from the data file,
wherein the web browser is further configured to provide the data file to the file protection service together with identification associated with the user of the web browser and a request to remove the identification of the predefined data restriction from the data file,
wherein the file protection service is further configured to
access the decryption key that is configured to decrypt the data file,
decrypt the data file using the decryption key,
remove the identification of the predefined data restriction from the data file, and
provide the decrypted data file to the web browser, and
wherein the web browser is further configured to send the decrypted data file via the computer network.

14. A computer network security system comprising:
a web browser configured to determine in accordance with any predefined policy that a data file may be sent via a computer network after decryption and removal of identification of a predefined data restriction from the data file; and
a file protection service configured to
receive, from the web browser, identification associated with a user of the web browser and a request to remove the identification of the predefined data restriction from the data file,
access a decryption key that is configured to decrypt the data file,
decrypt the data file using the decryption key,
remove the identification of the predefined data restriction from the data file, and
provide the decrypted data file to the web browser, and
wherein the web browser is further configured to send the decrypted data file via the computer network.
